(19) United States
(12) Patent Application Publication
(10) Pub. No.: US 2008/0150275 A1
(43) Pub. Date: Jun. 26, 2008

(54) AUXILIARY PRESCRIPTION LABEL

(76) Inventor: DAVID B. RAISTRICK, BLOOMINGTON, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/962,516

(22) Filed: Dec. 21, 2007

Related U.S. Application Data
(60) Provisional application No. 60/871,325, filed on Dec. 21, 2006.

(51) Int. Cl. B42D 15/10

(52) U.S. Cl. 283/81

(57) ABSTRACT

An auxiliary label and an auxiliary label assembly is formed from a laser label form. A top layer of the form is formed of PVC static-cling vinyl and can have information printed thereon. The auxiliary label contains limited prescription details, such as drug name, dosage, and instructions. The auxiliary label is secured to the prescription container at one end thereof and wraps around the container and is secured to itself or to the container via static cling. The auxiliary label does not affect the use of the standard prescription label applied by the pharmacy which is governed by state and federal law. Using such an auxiliary label not only increases the print size, but also allows the user to read the prescription label in a flat planar fashion. Warning labels and/or RFID tags may also be associated with the auxiliary label to form the auxiliary label assembly.

### CROSS-REFERENCE AND INCORPORATION BY REFERENCE

This patent application claims the benefit of domestic priority of U.S. Provisional Application Ser. No. 60/871,325, filed Dec. 21, 2006, and entitled “Large Print Auxiliary Prescription Label”. U.S. Provisional Application Ser. No. 60/871,325 is hereby incorporated by reference.

### BACKGROUND OF THE INVENTION

Prescription medications are an important part of maintaining good health and well-being. Everyday, millions of people attempt to adhere to their prescribing physician's strict regimen. Doctors rely on the pharmacist to help distribute (and in some cases formulate) medications. The pharmacist is a key link in the healthcare system in informing and educating patients. These pharmacists ensure that prescriptions are accurately and legally labeled for each and every patient. It stands to reason that prescription labels placed on medications play an extremely critical role in allowing patients safe administration of their medication(s) along with medication(s) of loved ones.

The nature and extent of medication information that pharmacies are required to provide their customers has been the subject of complex, overlapping and evolving state and federal regulation. The justification for this regulation is readily apparent upon review of reports estimating the number of deaths and other adverse health consequences related to medication errors in the United States each year. (See John P. Santell, et al., Medication Error Trends for 1999-2003, 149(4) Drug Topics HSE22(Feb. 21, 2005), Committee on Quality of Health Care in America, Institute of Medicine, To Err is Human—Building a Safer Health System (1999), available at http://www.iom.edu/includes/DBFile.asp?id=4117, and Susan Camp and Rodney Hicks, Medication Errors in the Patient's Home, 148(8) Drug Topics HSE14(Apr. 19, 2004)). The Food and Drug Administration's Center for Drug Evaluation and Research states that “medication errors cause at least one death every day and injure approximately 1.3 million people annually in the United States.”(See, http://www.fda.gov/cder/handbook/mederror.htm (last visited Aug. 29, 2005)). The problem is so significant that the American Pharmacists Association stresses that prescription medication users should “double check the label and the contents” prior to taking a medication. (See, Pharmacists offer tips to help patients avoid medication errors, Patient Care Law Weekly, pg. 29, (Aug. 21, 2005)). The association also warns prescription users to “read the label and follow the directions. Medications are powerful, that's why they work. But they can cause harm as well, particularly if they are not used correctly. Follow the directions on the label.” (See, Pharmacists offer tips to help patients avoid medication errors, Patient Care Law Weekly, pg. 29, (Aug. 21, 2005)).

Another important requirement designed to protect the health and welfare of prescription medication consumers is the requirement that pharmacies securely affix certain basic information to the prescription medication containers they dispense to customers. At least 31 State legislatures and the District of Columbia have enacted such a requirement (See, Ark. Code Ann. §20-64-210; Cal. Bus & Prof Code §4076; Colo. Rev. Stat. §12-22-123; Conn. Gen. Stat. §21a-256; Del. Code Ann. tit. 24, §2536; D.C. Code Ann. §48-903.08; Fla. Stat. Ann. §§465.186 and 893.04; Haw. Rev. Sta. §§329-38 and 39; Idaho Code §§37-2731 and 54-1732; Ill. Rev. Stat. ch. 225, para. 85/22 and ch. 720, para. 570/312; Ind. Code Ann. §16-42-19-11; Ky. Rev. Stat. Ann. §218A.180; La. Rev. Stat. Ann. §37:1164; Md. Crim. Law Code Ann. §§5-505 and 5-701; Mass. Gen. Laws Ann. ch. 94C, §§21 and 27; Minn. Stat. Ann. §151.212; Mo. Rev. Stat. §§195.100 and 338.059; Neb. Rev. Stat. §28-415; Nev. Rev. Stat. Ann. §§585.420 and 639.2801; N.H. Rev. Stat. Ann. §318:47-a; N.J. Stat. Ann. §§24:21-17 and 45:14-15; N.M. Stat. Ann. §30-31-18; N.Y. Educ. Law §6810; N.C. Gen. Stat. §106-134.1; N.D. Cent. Code, §19-02.1-14.1; Ohio Rev. Code Ann. §3719.08; Okl. Stat. Ann. tit. 59, §355.1 and tit. 63, §2-314; Or. Rev. Stat. §689.505; Tex. Occ. Code §567.001; Utah Code Ann. §58-17b-602; Vt. Stat. Ann. tit. 18, §4212; Wash. Rev. Code Ann. §69.41.050; and Wis. Stat. Ann. §450.11). The obvious benefit of the requirement is to help prevent medication errors such as the accidental consumption of the wrong prescription medication.

Primarily because of the print size, many people with sight impairment have difficulty reading their prescription labels. The print size on a prescription label is typically small because of the amount of legally required information and the limited label space provided on the standard prescription vial, box, bottle, etc. With limited space, pharmacies are forced to reduce the print size to include all the important and pertinent facts on these all-too-important labels.

Also, individuals with sight impairment find it difficult to read prescription labels wrapped around a prescription vial, bottle or box. Adding to this, those with severe sight impairment use additional lighting and magnifiers to attempt to improve their ability to read their prescriptions. When prescriptions are magnified to a large scale, it can be even more difficult to maintain reading continuity around a prescription vial.

There have been several attempts to improve on the availability of prescription label information including ECL or Expanded Content Labels. Several concepts proposed include adhering multi-ply labels and low-tack adhesive labels to a prescription product's package. These concepts do not address the need for provided pharmacy delivered large print versions of the most critical information.

U.S. Pat. No. 6,860,513 describes a folding Expanded Content Label. This patent details a pharmacy label that folds onto itself and uses adhesive lining and a silicone back liner that folds over itself to create a label tab that continues radially from the prescription.

U.S. Pat. No. 6,938,771 provides a film wrapped container which has a shrinkable PVC (vinyl) wrap that is removable by the user. This wrap does not wrap upon itself and is not re-sealable by the user.

Wrap around labels are well-known to those skilled in the art of label generation. Several patents have disclosed label strips that are applied to the entire perimeter with additional length that continue to wrap onto themselves.

U.S. Pat. No. 5,855,395 describes a particular pharmacy label that when printed, allows the pharmacist to simultaneously remove printed warning labels while removing the main prescription label. U.S. Pat. No. 6,189,936 discloses a prescription label that has two-ply construction making it easy for a pharmacist to remove additional portions of the form including warning at the same time. Although both of these patents make managing warning labels inside the pharmacy easier, they do not provide for a more readable large print pharmacy warnings.

U.S. Pat. No. 6,752,431 describes a re-sealable, multi-ply label that has a permanent portion along with a re-sealable second portion.

The prior art discussed herein provides several deficiencies for sight impaired users. All of the prior art, including the wrap around labels, disclose the use of adhesive to allow for removability of the label. During use, dirt and grime will easily foul an adhesive which reduces the adhesion.

Recently introduced devices, such as those using SCRIPTALK® hardware, as disclosed in U.S. Pat. No. 6,877,658 which is owned by the present assignee, have alleviated some of the problems for sight impaired patients by speaking out the label information using text-to-speech technology. Other technologies, like Talking Rx, allow the pharmacist to record information into an augmented pill bottle puck in order to easily get label information spoken. Although devices such as these are a welcomed benefit to patients that have no useable vision, they create a burden to those that have enough useable vision to read larger print labels.

### SUMMARY OF THE INVENTION

The present invention provides a system and method for accurately delivering large print prescription label information to a patient using a specifically designed auxiliary laser label form. Such an auxiliary label, which is printable by a standard pharmacy printer, can be applied to a prescription label. The auxiliary label contains only the most important prescription details, such as drug name, dosage, and instructions. The auxiliary label wraps around the prescription container and does not affect the use of the standard prescription label applied by the pharmacy which is governed by state and federal law. Using such an auxiliary label not only increases the print size, but also allows the user to read the prescription label in a flat planar fashion, rather than curved around the surface of the prescription vial or receptacle. Large print warnings can also be associated with the auxiliary label on a warning label that is either fixedly secured to the auxiliary label by an adhesive or which is integrally formed with the auxiliary label such that it can be folded over the auxiliary label and secured thereto.

### DETAILED DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

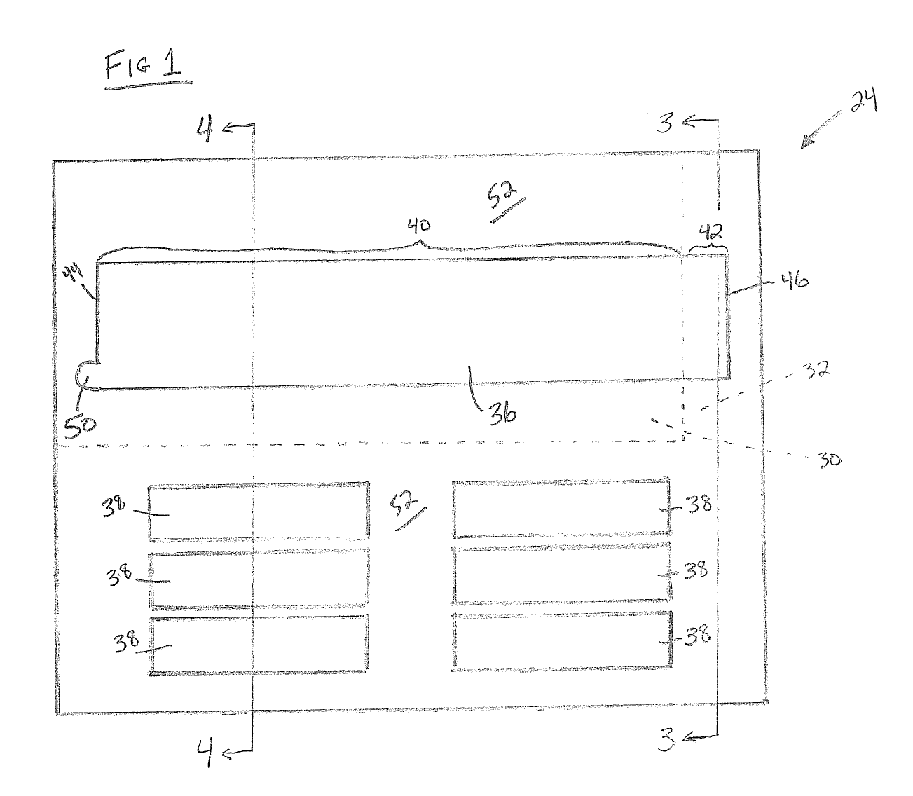

FIG. 1 is a top plan view of a laser label form used to form the auxiliary label and the auxiliary label assembly of the present invention;

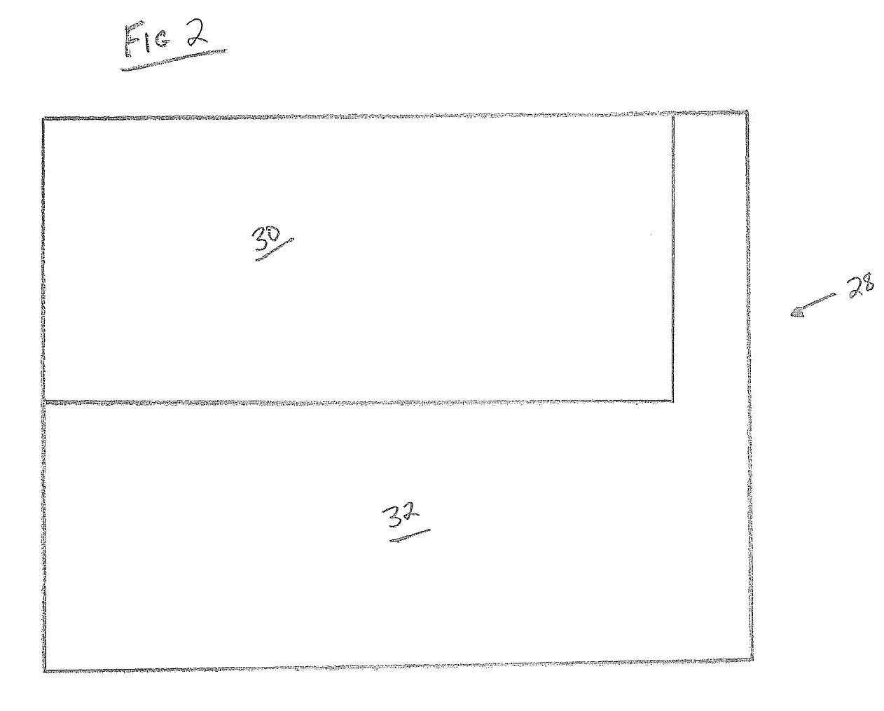

FIG. 2 is a top plan view of a bottom layer of the laser label form illustrated in FIG. 1;

FIG. 3 is a cross-sectional view of the laser label form taken along line 3-3 of FIG. 1;

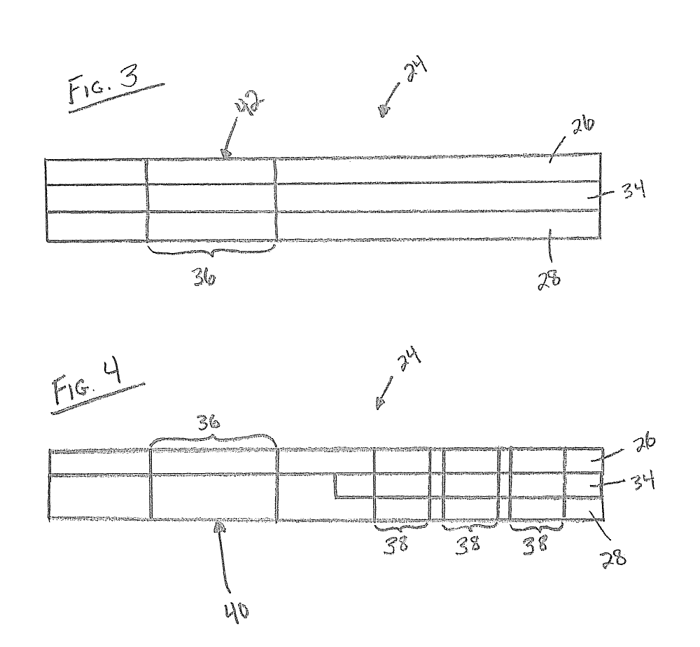

FIG. 4 is a cross-sectional view of the laser label form taken along line 4-4 of FIG. 1;

FIG. 5 is a side elevational view of a long label assembly die cut from the laser label form;

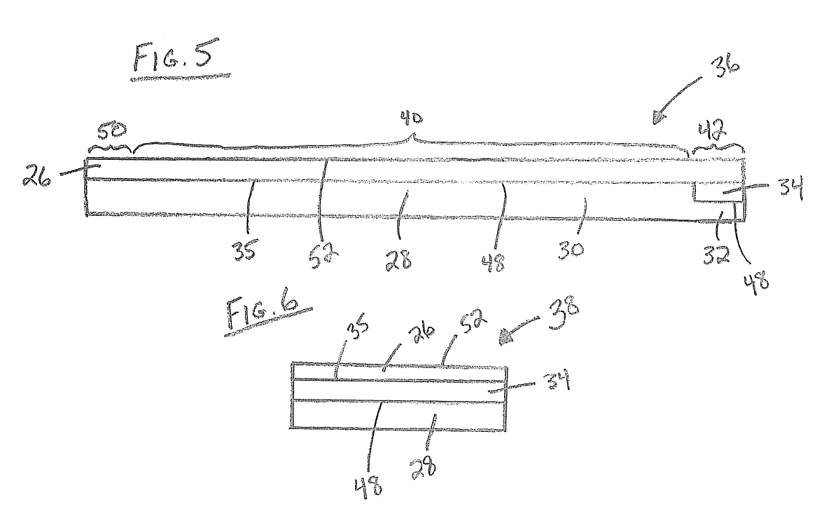

FIG. 6 is a side elevational view of a warning label assembly die cut from the laser label form;

FIG. 7 is a side elevational view of a prescription container having a prescription label fixedly secured thereto around an outer surface of the prescription container;

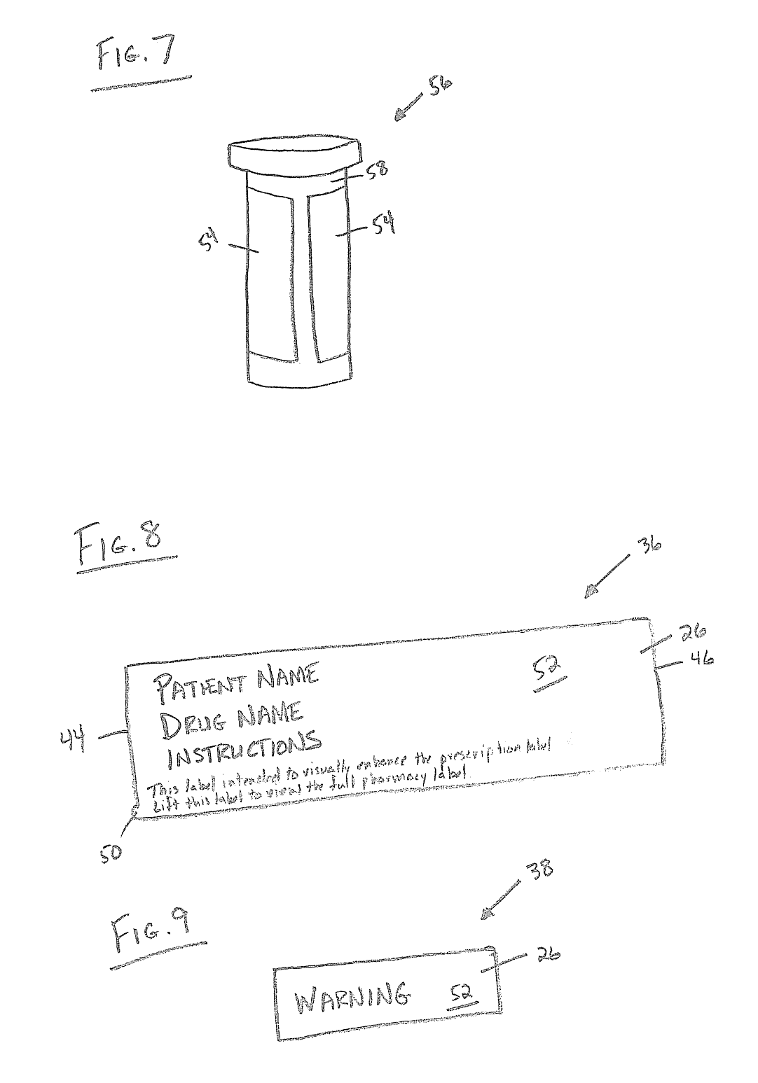

FIG. 8 is a top plan view of the long label assembly having information printed thereon;

FIG. 9 is a top plan view of the warning label assembly having warning information printed thereon;

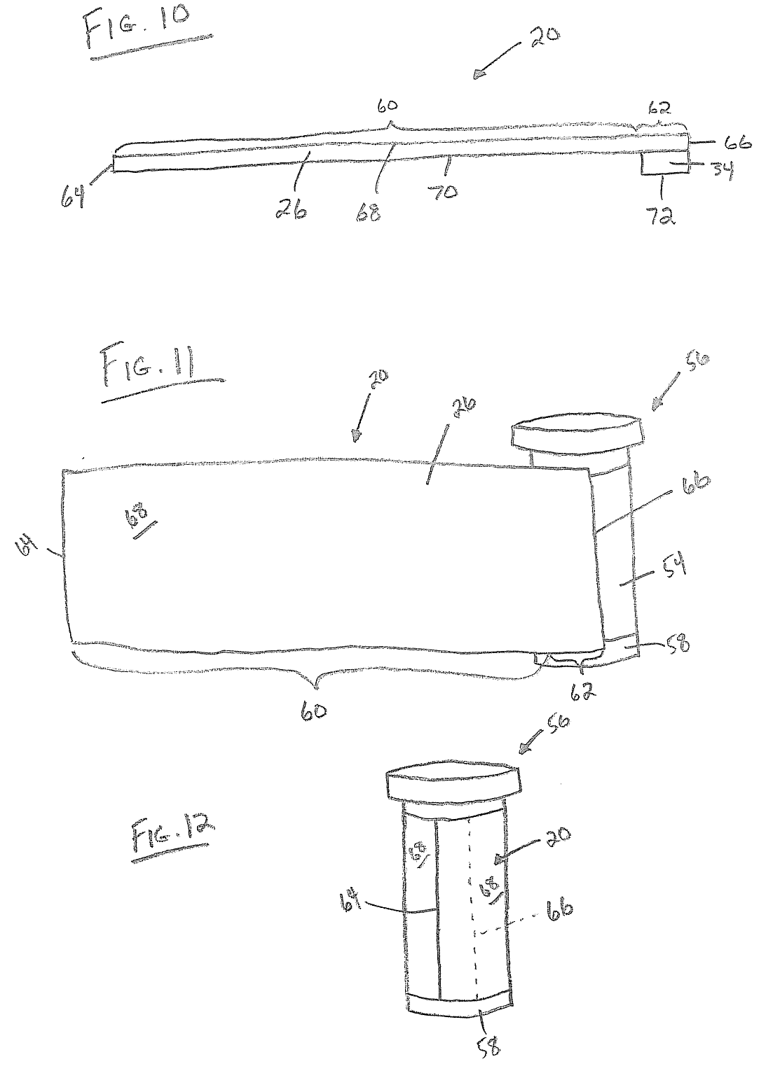

FIG. 10 is a side elevational view of the auxiliary label of the present invention;

FIG. 11 is a side elevational view of the auxiliary label of the present invention secured to a prescription container;

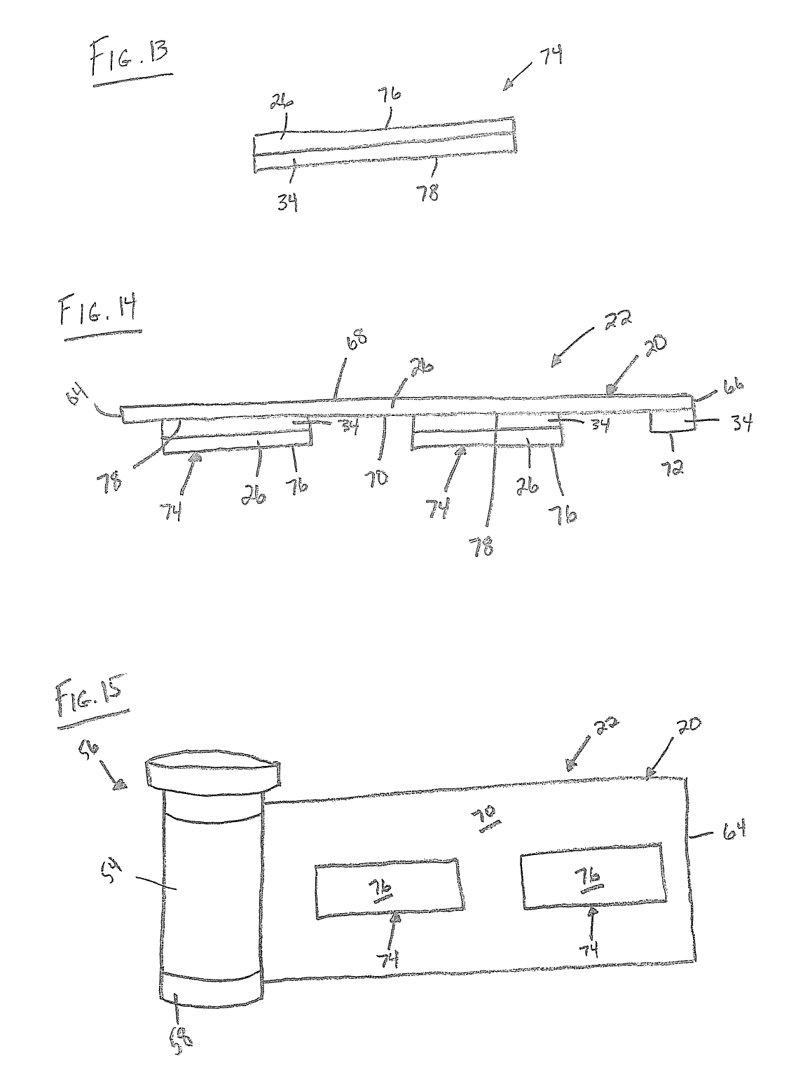

FIG. 12 is a side elevational view of the auxiliary label of the present invention wrapped around the prescription container and secured to itself via static cling;

FIG. 13 is a side elevational view of a warning label;

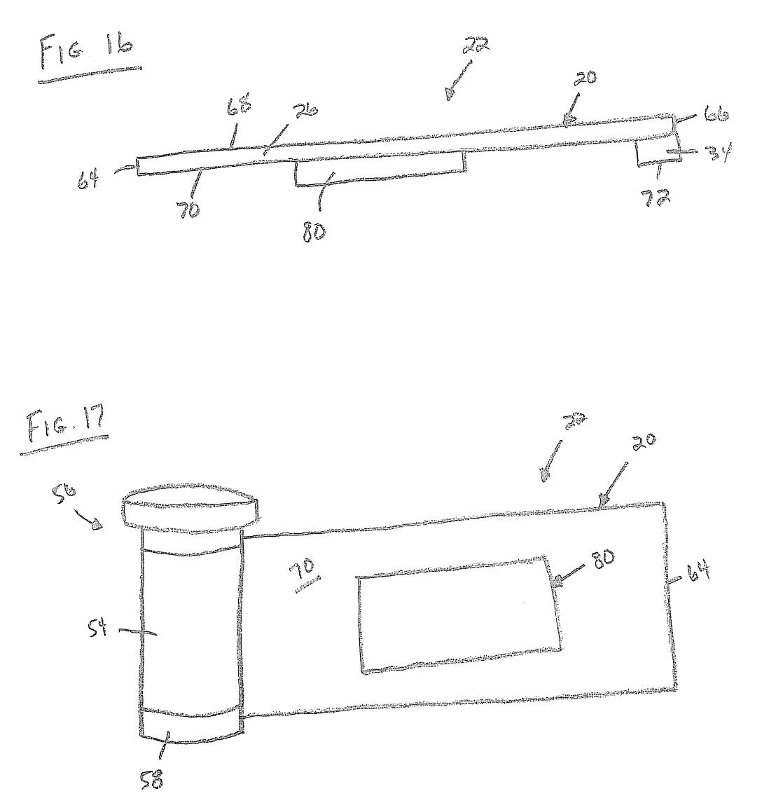

FIG. 14 is a side elevational view of the auxiliary label system of the present invention having a pair of warning labels fixedly secured thereto;

FIG. 15 is a side elevational view of the auxiliary label system of FIG. 14 secured to a prescription container;

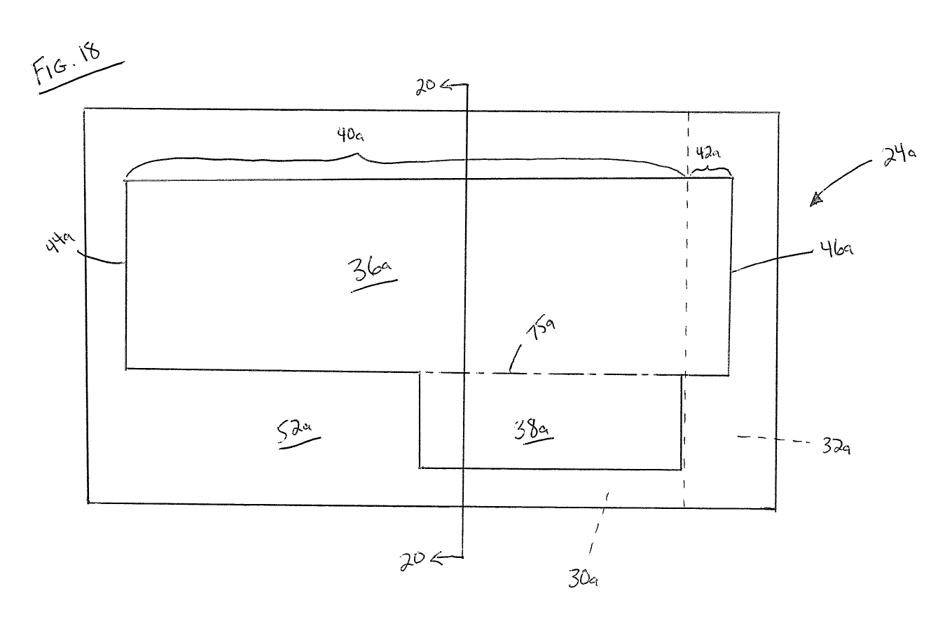

FIG. 16 is a side elevational view of the auxiliary label system of the present invention having an RFID tag fixedly secured thereto;

FIG. 17 is a side elevational view of the auxiliary label system of FIG. 16 secured to a prescription container;

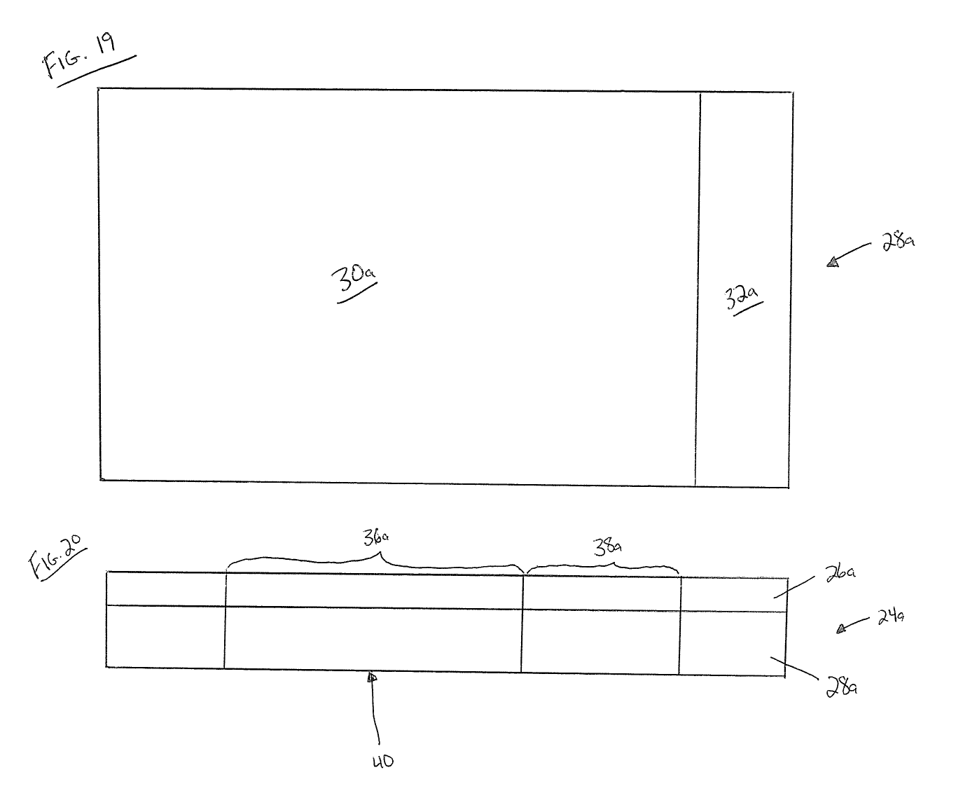

FIG. 18 is a top plan view of an alternative laser label form used to form an alternative auxiliary label and the alternative auxiliary label assembly of the present invention;

FIG. 19 is a top plan view of a bottom layer of the alternative laser label form illustrated in FIG. 18;

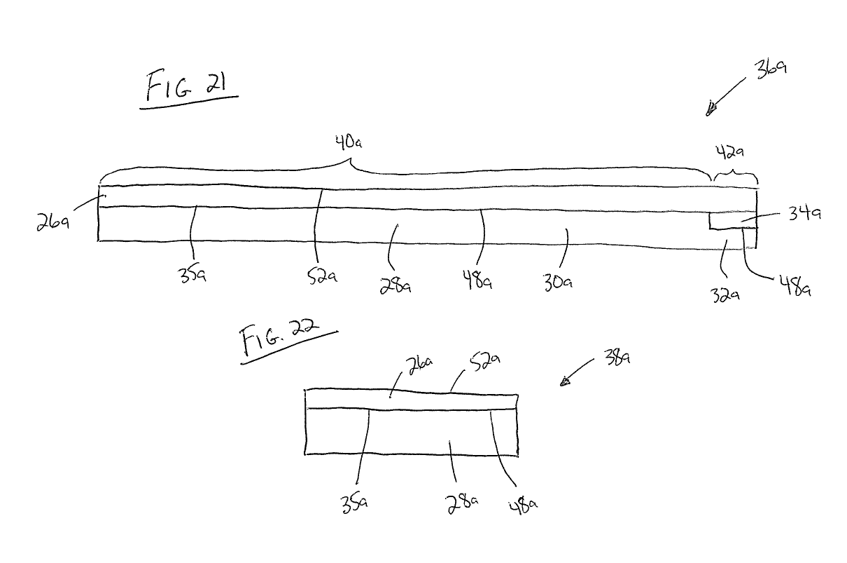

FIG. 20 is a cross-sectional view of the alternative laser label form taken along line 20-20 of FIG. 18;

FIG. 21 is a side elevational view of a long label assembly die cut from the alternative laser label form;

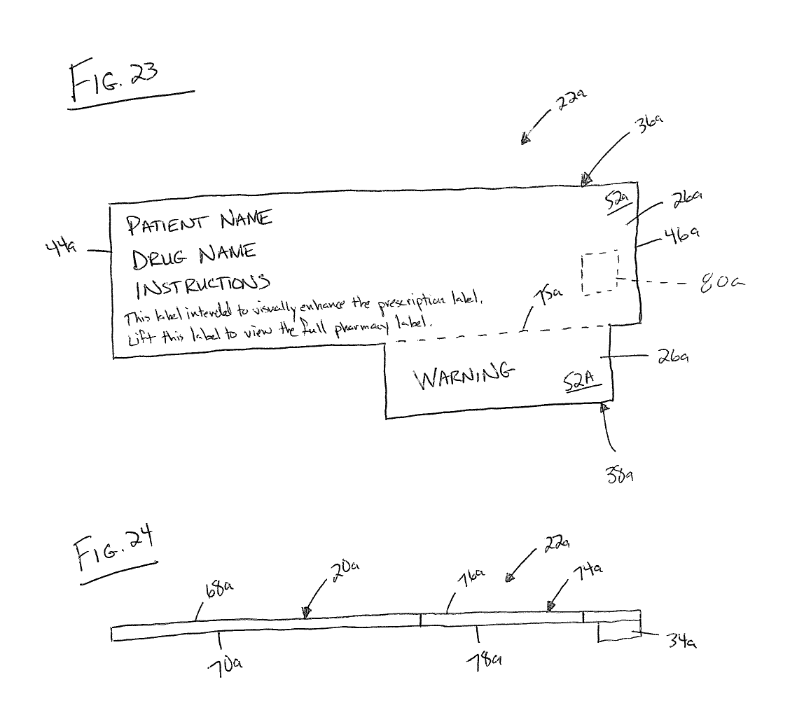

FIG. 22 is a side elevational view of a warning label assembly die cut from the alternative laser label form;

FIG. 23 is a top plan view of the alternative auxiliary label assembly having information printed thereon;

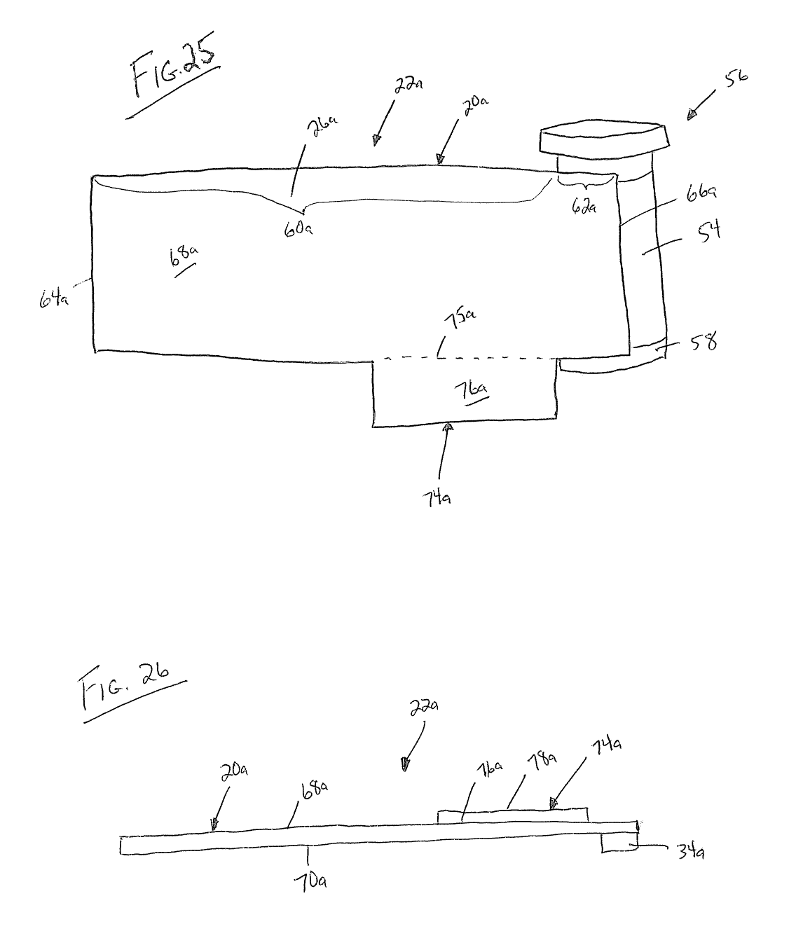

FIG. 24 is a side elevational view of the alternative auxiliary label assembly illustrated in FIG. 23, with the warning label assembly in an unfolded position such that the warning information printed thereon is visible;

FIG. 25 is a side elevational view of the alternative auxiliary label assembly of the present invention secured to a prescription container, with the warning label assembly in an unfolded position such that the warning information printed thereon is visible;

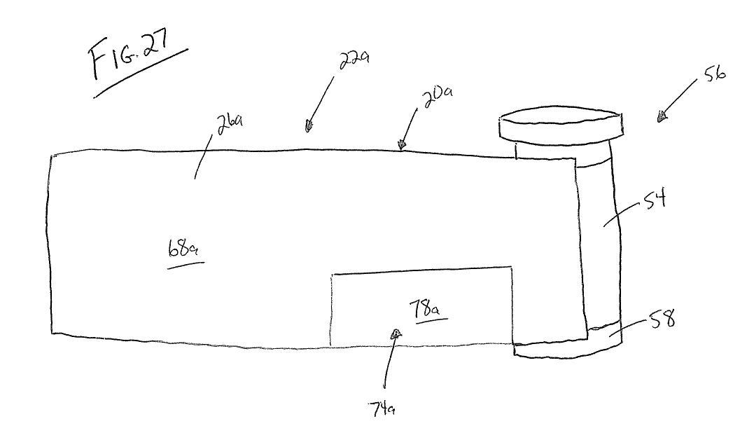

FIG. 26 is a side elevational view of the alternative auxiliary label assembly, with the warning label assembly in a folded position such that the warning information printed thereon is not visible; and

FIG. 27 is a side elevational view of the alternative auxiliary label assembly of the present invention secured to a prescription container, with the warning label assembly in a folded position such that the warning information printed thereon is not visible.

### DETAILED DESCRIPTION OF THE PREFERRED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

Because it is considered that all the previous developments and inventions fall short of providing individuals with limited sight the critical information they need, there is a need for an improved label that will meet legal requirements in an easy to read format. The present auxiliary label 20 and the auxiliary label assembly 22, which includes the auxiliary label 20, both meet this requirement.

The auxiliary label 20 and at least a portion of the auxiliary label assembly 22 are formed from a laser label form 24 that can be manufactured for a relative nominal cost using standard label making equipment. As best illustrated in FIGS. 3 and 4, this form 24 includes a top substrate or layer 26 of laser-printable, PVC static-cling vinyl. The vinyl is also smudge-proof and tear-proof. This top layer 26 is printable by adding chemicals to allow the laser fusion print in the typical laser printer to adhere to the surface of the vinyl. The form 24 includes a bottom substrate or layer 28 which is formed from a dual material. As shown in FIG. 2, at least one portion 30 of the bottom layer 28 is formed of a liner which can be releasably secured to a PVC static-cling vinyl, and at least one portion 32 is formed of a liner which can be releasably secured to a pressure sensitive adhesive. A pressure sensitive adhesive 34 forms a middle layer between predetermined sections of the top layer 26 and the bottom layer 28. The adhesive 34 is permanently affixed to predetermined sections of a lower surface 35 (the surface that faces the bottom layer 28) of the top layer 26. The adhesive 34 is only provided between the portions 32 of the bottom layer 28, where the release liner for pressure sensitive adhesive is provided, and the top layer 26. The adhesive 34 is not provided between the portions 30 of the bottom layer 28, where the release liner for the PVC static-cling vinyl is provided, and the top layer 26.

The bottom layer 28 can be formed by using a process similar to a dual-web system of label form making. Dual web construction consists of joining a form and a label together side by side with a seamed glue line to form one single web.

Static cling vinyl is a PVC film formulation containing large amounts of liquid plasticizer, which renders the film extremely pliable. The vinyl is calendered to provide a smooth finish and when applied to a smooth, glossy surface it adheres without need of adhesives. As a result, the vinyl can be can be removed and re-applied indefinitely. Typical applications for static cling vinyl include window and other decorative graphics and special labels, e.g. oil change labels placed on car windshields.

Static cling vinyl has traditionally been printable using UV, flexo and offset processes. The form 24 described herein utilizes a vinyl static cling (or similar) material which is printable using a standard laser printer. Material such as this is sold by HPS LLC in Newark, Tex.

Once the layers 26, 28 and adhesive 34 are assembled to create the form 24, first and second components 36, 38 are die cut into the form 24, although it is to be understood that, if desired, further components could also be die cut into the form 24, or the components 36, 38 could be cut by other appropriate means.

The first component 36 is a long label assembly which is best illustrated in FIG. 5. The first component 36 has a first elongated portion 40 and a second condensed portion 42. The first elongated portion 40 extends from a first end 44 of the first component 36 to the second condensed portion 42 and the second condensed portion 42 extends from the first elongated portion 40 to a second end 46 of the first component 36.

The first elongated portion 40 is formed with the lower surface 35 of the top layer 26 being in contact with an upper surface 48 of the portion 30 of the bottom layer 28. Thus, in the first elongated portion 40, the portion 30 of the bottom layer 28 is releasably secured to the top layer 26. As illustrated in FIGS. 1 and 5, the first elongated portion 40 may have a grab tag 50 extending outwardly from the first end 44 of the first component 36.

The second condensed portion 42 is formed with the lower surface 35 of the top layer 26 being permanently affixed to the pressure sensitive adhesive 34 and with the pressure sensitive adhesive 34 being in contact with the upper surface 48 of the portion 32 of the bottom layer 28. Thus, in the second condensed portion 42, the portion 32 of the bottom layer 28 is releasably secured to the top layer 26.

The second component 38 is a plurality of warning labels. It is illustrated in FIG. 1 that six (6) warning labels are provided, although it is to be understood that more or less of the warning labels could be provided as desired. Each second component 38, as best illustrated in FIG. 6, is formed with the lower surface 35 of the top layer 26 being permanently affixed to the pressure sensitive adhesive 34 and with the pressure sensitive adhesive 34 being in contact with the upper surface 48 of the portion 32 of the bottom layer 28. Thus, in each second component 38, the portion 32 of the bottom layer 28 is releasably secured to the top layer 26.

After die cutting, the form 24 is fed into a typical pharmacy laser printer (not shown). The form 24 may preferably be 8½″×11″ in size. The laser printer prints on the first and second components 36, 38 on an upper surface 52 of the top layer 26 thereof using ordinary pharmacy software or specially developed software. Because the pharmacy can easily print on the first and second components 36, 38 of the form 24 using a standard laser printer, this provides a low cost form of labeling.

As discussed in the “Background of the Invention”, prescription labels 54 have a large amount of prescription information printed thereon, namely all information required by law and all other information included thereon by the pharmacy. As illustrated in FIG. 7, the prescription labels 54 are intended to be permanently affixed around an outer surface 58 of a prescription holding portion or container 56 such that they are not to be removed from the prescription container 56. Conversely, the laser printer only prints a subset of the prescription information provided on the prescription label 54, namely that which is critical, on the upper surface 52 of the top layer 26 of the first component 36. Preferably, as illustrated in FIG. 8, only the following information is printed in large print, for example, 20 point font, (so that a sight impaired patient can read the information) on the upper surface 52 of the first component 36: the patient's name, the drug's name, and instructions for administration of the drug to the patient. Preferably, the following statement is also printed in small print on the upper surface 52 of the first component 36: “This label intended to visually enhance the prescription label Lift this label to view the full pharmacy label.” The material provided in large print enables a sight impaired user to easily read the information. Likewise, as illustrated in FIG. 9, the laser printer may print warnings on the upper surface 52 of the top layer 26 of the second components 38. The laser printer may also print information and/or instructions for the pharmacist on the upper surface 52 of the top layer 26, outside of the boundaries of the first component 36 and the second components 38, e.g., instructions for how to assemble the auxiliary label 20 or the auxiliary label assembly 22 and instructions for how to secure the auxiliary label 20 or the auxiliary label assembly 22 to the prescription container 56 and/or the prescription label 54.

After printing, the first component 36 is manipulated to peel the top layer 26 and the adhesive 34 thereof from the bottom layer 28 thereof. As previously discussed, the top layer 26 of the first component 36 may have a grab tab 50 provided at the first end 44 thereof in order to assist in the peeling of the top layer 26 and the adhesive 34 from the bottom layer 28. The peeled top layer 26 and the adhesive 34 secured thereto form the auxiliary label 20.

As best illustrated in FIG. 10, the auxiliary label 20 has a first elongated portion 60 and a second condensed portion 62. The first elongated portion 60 extends from a first end 64 of the auxiliary label 20 to the second condensed portion 62 and the second condensed portion 62 extends from the first elongated portion 60 to a second end 66 of the auxiliary label 20.

The first elongated portion 60 is formed of only the top layer 26 and may have the grab tag (not shown) extending outwardly from the first end 64 of the auxiliary label 20. Upper and lower surfaces 68, 70 of the first elongated portion 60 are formed of the PVC static-cling vinyl with the upper surface 68 thereof having information printed thereon in large print.

The second condensed portion 62 is formed of the top layer 26 being permanently affixed to the pressure sensitive adhesive 34. Upper surface 68 of the second condensed portion 62 is formed of the PVC static-cling vinyl and may have information printed thereon in large print. Lower surface 72 of the second condensed portion 62 is formed of the pressure-sensitive adhesive.

The lower surface 72 of the second condensed portion 62 of the auxiliary label 20 is then fixedly secured directly to the prescription label 54 on the prescription container 56, assuming the prescription label 54 completely surrounds the outer surface 58 of the prescription container 56, or may be fixedly secured directly to the outer surface 58 of the prescription container 56 if the prescription label 54 does not completely surround the outer surface 58 of the prescription container 56 as illustrated in FIG. 11. If fixedly secured to the prescription label 54, the auxiliary label 20 should preferably be fixedly secured to a portion of the prescription label 54 that does not display any information thereon.

With the lower surface 72 of the second condensed portion 62 of the auxiliary label 20 secured to either the prescription label 54 or the prescription container 56, the first elongated portion 60 of the auxiliary label 20 is wrapped around the prescription label 54 and/or the prescription container 56 and onto itself such that at least a portion of the lower surface 70 of the first elongated portion 60 is positioned against at least a portion of the upper surface 68 of the second condensed portion 62 and releasably secured thereto because of the static cling properties of the PVC static-cling vinyl. As illustrated in FIG. 12, the auxiliary label 20 wraps around the prescription container 56, covers the prescription label 54, and is releasably secured to itself. Depending on the material from which the prescription label 54 and the prescription container 56 are formed, the auxiliary label 20 may also be releasably secured to one or both of the prescription label 54 and the prescription container 56.

After printing, one or more of the second components 38 is manipulated to peel the top layer 26 and the adhesive 34 thereof from the bottom layer 28 thereof. If desired, although not shown, the top layer 26 of the second components 38 may have a grab tab provided at an end thereof in order to assist in the peeling of the top layer 26 and the adhesive 34 from the bottom layer 28. The peeled top layer 26 and the adhesive 34 secured thereto form the warning label 74. As illustrated in FIG. 13, the warning label 74 is formed of the top layer 26 being permanently affixed to the pressure sensitive adhesive 34. Upper surface 76 of the warning label 74 is formed of the PVC static-cling vinyl and may have information printed thereon. The information on the warning label 74 includes warnings regarding the drug and is printed in large print, for example, 20 point font, (so that a sight impaired patient can read the information) on the upper surface 76 of the warning label 74. The material provided in large print enables a sight impaired user to easily read the information. Lower surface 78 of the warning label 74 is formed of the pressure-sensitive adhesive.

Prior to the auxiliary label 20 being fixedly secured to one or both of the prescription label 54 and the prescription container 56, or with the auxiliary label 20 either fixedly secured to one or both of the prescription label 54 and the prescription container 56, the lower surface 78 of each warning label 74 is fixedly secured against the lower surface 70 of the first elongated portion 60 of the auxiliary label 20 in order to form the auxiliary label assembly 22 as illustrated in FIGS. 14 and 15. Because the upper surfaces 76 of the warning labels 74 are made from the same static cling vinyl as the upper surfaces 68 of the first elongated portion 60 and the second condensed portion 62 and the lower surface 70 of the first elongated portion 60 of the auxiliary label 20, the fixed securement of the warning labels 74 to the auxiliary labels 20 does not effect the ability of the auxiliary label 20 to adhere to itself, to the prescription label 54 and/or to the prescription container 56. Because the upper surface 76 of the warning labels 74 are formed from the PVC static-cling vinyl, which is the side of the warning labels 74 which faces the prescription label 54 and the prescription container 56, the warning labels 74 do not impede the attachment of the auxiliary label assembly 22 to the prescription label 54 and/or the prescription container 56, nor do they impede the repeated detachment/reattachment of the auxiliary label assembly 22 to the prescription label 54 and/or the prescription container 56.

The auxiliary label assembly 22 may alternatively include an RFID tag 80 fixedly secured thereto. The RFID tag 80 may be used in place of the warning labels 74 or in conjunction with the warning labels 74. As illustrated in FIGS. 16 and 17, the RFID tag 80 is fixedly secured via an adhesive or other appropriate means to the lower surface 70 of the first elongated portion 60 of the auxiliary label 20. The auxiliary label assembly 22 having the RFID tag 80 fixedly secured thereto would make the auxiliary label assembly 22 readable using a talking RFID reader (Audible Prescription Reading Device) (not shown).

After the auxiliary label 20 or the auxiliary label assembly 22 is fixedly secured to the prescription label 54 and/or the prescription container 56, with the auxiliary label 20 being wrapped around and possibly releasably secured to the prescription label 54 and/or the prescription container 56 and, if the auxiliary label 20 is long enough, releasably secured to itself, the prescription container 56 is provided to the sight-impaired patient.

In use by the sight-impaired patient, the patient will unwrap the auxiliary label 20 or the auxiliary label assembly 22 (although they are still fixedly secured to the prescription label 54 and/or the prescription container 56 by the adhesive 34 of the second condensed portion 62 of the auxiliary label 20) and pull or lay it flat. The information printed on the upper surface 68 of the auxiliary label 20 can then be read very easily by the sight-impaired patient. In addition, upon turning the auxiliary label assembly 22 over, the sight-impaired patient can easily read the information printed on the upper surface 76 of the warning labels 74 and/or use the talking RFID reader to read the information stored on the RFID tag 80.

It should be noted that neither the auxiliary label 20 nor the auxiliary label assembly 22 permanently obscures the legally dictated, standard prescription label 54.

Because a PVC static-cling vinyl is used, and not a low tack adhesive, dirt and grime which accumulates during use will not foul the adhesion of the auxiliary label 20 or the auxiliary label assembly 22 to either the prescription label 54 or the prescription container 56, which occurs with the low tack adhesive. In addition, handling an adhesive backed elongated strip is considerably more difficult and undesirable than would be a static cling wrap label.

It should be noted that, if desired, the first component 36 and the second components 38 may first be removed from the form 24 before peeling the top layers 26 and the adhesives 34 secured thereto from the bottom layers 28 thereof, or the top layers 26 and the adhesives 34 secured thereto may be peeled from the bottom layers 28 thereof without first removing the first component 36 and the second components 38 from the form 24.

FIGS. 18-27 illustrate an alternative embodiment of the invention. The alternative embodiment is described with like reference numerals to those in the foregoing embodiment with the reference numerals in the alternative embodiment ending with the letter “a”.

The auxiliary label 20a and at least a portion of the auxiliary label assembly 22a are formed from a laser label form 24a that can be manufactured for a relative nominal cost using standard label making equipment. Like the form 24, the form 24a includes a top substrate or layer 26a of laser-printable, PVC static-cling vinyl, and a bottom substrate or layer 28a which is formed from a dual material. As shown in FIG. 19, at least one portion 30a of the bottom layer 28a is formed of a liner which can be releasably secured to a PVC static-cling vinyl, and at least one portion 32a is formed of a liner which can be releasably secured to a pressure sensitive adhesive. A pressure sensitive adhesive 34a forms a middle layer between predetermined sections of the top layer 26a and the bottom layer 28a. The adhesive 34a is permanently affixed to predetermined sections of a lower surface 35a of the top layer 26a. The adhesive 34a is only provided between the portions 32a of the bottom layer 28a and the top layer 26a. The adhesive 34a is not provided between the portions 30a of the bottom layer 28a and the top layer 26a.

Once the layers 26a, 28a and adhesive 34a are assembled to create the form 24a, first and second components 36a, 38a are die cut into the form 24a, although it is to be understood that, if desired, further components could also be die cut into the form 24a, or the components 36a, 38a could be cut by other appropriate means.

The first component 36a is a long label assembly which is best illustrated in FIGS. 18 and 21. The first component 36a has a first elongated portion 40a and a second condensed portion 42a. The first elongated portion 40a extends from a first end 44a of the first component 36a to the second condensed portion 42a and the second condensed portion 42a extends from the first elongated portion 40a to a second end 46a of the first component 36a.

The first elongated portion 40a is formed with the lower surface 35a of the top layer 26a being in contact with an upper surface 48a of the portion 30a of the bottom layer 28a. Thus, in the first elongated portion 40a, the portion 30a of the bottom layer 28a is releasably secured to the top layer 26a. If desired, the first elongated portion 40a may have a grab tab (not shown), similar to grab tag 50 on the first elongated portion 40, extending outwardly from the first end 44a of the first component 36a.

The second condensed portion 42a is formed with the lower surface 35a of the top layer 26a being permanently affixed to the pressure sensitive adhesive 34a and with the pressure sensitive adhesive 34a being in contact with the upper surface 48a of the portion 32a of the bottom layer 28a. Thus, in the second condensed portion 42a, the portion 32a of the bottom layer 28a is releasably secured to the top layer 26a.

The second component 38a is a warning label that is foldably attached to the first component 36a along a perforated line 75a. The second component 38a is integrally formed with the first component 36a, unlike the second components 38 of the first embodiment which are separated formed from the first component 36. More than one second component 38a may be foldably attached to the first component 36a if desired, although the invention is described and illustrated with only one second component 38a foldably attached to the first component 36a. The second component 38a, as best illustrated in FIGS. 20 and 22, is formed with the lower surface 35a of the top layer 26a being in contact with an upper surface 48a of the portion 30a of the bottom layer 28a. Thus, in the second component 38a, the portion 30a of the bottom layer 28a is releasably secured to the top layer 26a.

After die cutting, the form 24a is fed into a typical pharmacy laser printer (not shown). The form 24a may preferably be 8½″×11″ in size. The laser printer prints on the first and second components 36a, 38a on an upper surface 52a of the top layer 26a using ordinary pharmacy software or specially developed software. Because the pharmacy can easily print on the first and second components 36a, 38a of the form 24a using a standard laser printer, this provides a low cost form of labeling.

The laser printer only prints a subset of the prescription information provided on the prescription label 54, namely that which is critical, on the upper surface 52a of the top layer 26a of the first component 36a. Preferably, as illustrated in FIG. 23, only the following information is printed in large print, for example, 20 point font, on the upper surface 52a of the first component 36a: the patient's name, the drug's name, and instructions for administration of the drug to the patient. Preferably, the following statement or the like is also printed in small print on the upper surface 52a of the first component 36a: “This label intended lo visually enhance the prescription label. Lift this label to view the full pharmacy label.” Likewise, as illustrated in FIG. 23, the laser printer may print warnings on the upper surface 52a of the top layer 26a of the second components 38a. The laser printer may also print information and/or instructions for the pharmacist on the upper surface 52a of the top layer 26a, outside of the boundaries of the first and second components 36a, 38a, e.g., instructions for how to assemble the auxiliary label 20a or the auxiliary label assembly 22a and instructions for how to secure the auxiliary label 20a or the auxiliary label assembly 22a to the prescription container 56 and/or the prescription label 54.

After printing, the first component 36a is manipulated to peel the top layer 26a and the adhesive 34a thereof from the bottom layer 28a thereof. As previously discussed, the peeled top layer 26a and the adhesive 34a secured thereto form the auxiliary label 20a.

As best illustrated in FIGS. 24-27, the auxiliary label 20a has a first elongated portion 60a and a second condensed portion 62a. The first elongated portion 60a extends from a first end 64a of the auxiliary label 20a to the second condensed portion 62a and the second condensed portion 62a extends from the first elongated portion 60a to a second end 66a of the auxiliary label 20a.

The first elongated portion 60a is formed of only the top layer 26a. Upper and lower surfaces 68a, 70a of the first elongated portion 60a are formed of the PVC static-cling vinyl with the upper surface 68a thereof having information printed thereon in large print.

The second condensed portion 62a is formed of the top layer 26a being permanently affixed to the pressure sensitive adhesive 34a. Upper surface 68a of the second condensed portion 62a is formed of the PVC static-cling vinyl and may have information printed thereon in large print. Lower surface 72a of the second condensed portion 62a is formed of the pressure-sensitive adhesive.

The lower surface 72a of the second condensed portion 62a of the auxiliary label 20a is then fixedly secured directly to the prescription label 54 on the prescription container 56, assuming the prescription label 54 completely surrounds the outer surface 58 of the prescription container 56, or may be fixedly secured directly to the outer surface 58 of the prescription container 56 if the prescription container 54 does not completely surround the outer surface 58 of the prescription container 56 as illustrated in FIGS. 25 and 27. If fixedly secured to the prescription label 54, the auxiliary label 20a should preferably be fixedly secured to a portion of the prescription label 54 that does not display any information thereon.

With the lower surface 72a of the second condensed portion 62a of the auxiliary label 20a secured to either the prescription label 54 or the prescription container 56, the first elongated portion 60a of the auxiliary label 20a is wrapped around the prescription label 54 and/or the prescription container 56 and onto itself such that at least a portion of the lower surface 70a of the first elongated portion 60a is positioned against at least a portion of the upper surface 68a of the second condensed portion 62a and releasably secured thereto because of the static cling properties of the PVC static-cling vinyl. The auxiliary label 20a wraps around the prescription container 56, covers the prescription label 54, and is releasably secured to itself. Depending on the material from which the prescription label 54 and the prescription container 56 are formed, the auxiliary label 20a may also be releasably secured to one or both of the prescription label 54 and the prescription container 56.

After printing, the peeling of the top layer 26a of the first component 36a also causes the second component 38a to be manipulated such that the top layer 26a is peeled away from the bottom layer 28a to provide the warning label 74a. The peeling of the first and second components 36a, 38a from the bottom layer 28a forms the auxiliary label assembly 22a.

The warning label 74a is formed of only the top layer 26a. Upper and lower surfaces 76a, 78a of the warning label 74a are formed of the PVC static-cling vinyl with the upper surface 76a having warning information printed thereon. The warning information on the warning label 74a includes warnings regarding the drug and is printed in large print, for example, 20 point font, on the upper surface 76a of the warning label 74a.

With the auxiliary label 20a being fixedly secured to one or both of the prescription label 54 and the prescription container 56, the warning label 74a extends outwardly from the auxiliary label 20a. When the warning label 74a is in a position where it extends outwardly from the auxiliary label 20a, the upper surface 76a of the warning label 74a having the warning information printed thereon is visible, as illustrated in FIG. 25. When the auxiliary label 20a is wrapped around the prescription container 56 and the first end 64a thereof is secured to the prescription label 54 or the prescription container 56, the warning label 74a is first preferably folded along the perforated line 75a until either the upper surface 76a of the warning label 74a is attached to the upper surface 68a of the auxiliary label 20a (as shown in FIG. 27) via static cling or until the lower surface 78a of the warning label 74a is attached to the lower surface 70a of the auxiliary label 20a(not shown) via static cling, such that the auxiliary label assembly 22a is secured to one or both of the prescription label 54 and the prescription container 56.

Because the upper and lower surfaces 76a, 78a of the warning labels 74a are made from the same static cling vinyl as the upper and lower surfaces 68a, 70a of the auxiliary label 20a, the folding of the warning labels 74a over the auxiliary labels 20a does not affect the ability of the auxiliary label assembly 22a to adhere to itself, to the prescription label 54 and/or to the prescription container 56. Because the surfaces 76a, 78a of the warning labels 74a are formed from the PVC static-cling vinyl, the warning labels 74a do not impede the attachment of the auxiliary label assembly 22a to the prescription container 54 and/or the prescription container 56, nor do they impede the repeated detachment/reattachment of the auxiliary label assembly 22a to the prescription label 54 and/or the prescription container 56.

Alternatively, if desired, the warning label 74a can be detached from the auxiliary label 20a by tearing along the perforated line 75a. The warning label 74a can then be removed, if desired, or positioned on a different place on one of the surfaces 68a, 70a of the auxiliary label 20a than it would be were it to only be folded over onto the surfaces 68a, 70a of the auxiliary label 20a.

This alternative embodiment of the invention allows for the elimination of the adhesive from the warning label 74a, unlike the adhesive 34 require for the warning label 74.

If desired, the auxiliary label assembly 22a may alternatively or also include an RFID tag 80a fixedly secured thereto, similar to the RFID tag 80.

In use by the sight-impaired patient, the patient will unwrap the auxiliary label assembly 22a and pull or lay it flat. The warning label 74a will either be folded downwardly along perforated line 75a or, if having already been torn along perforated line 75a, will be removed from auxiliary label 20a, such that the information printed on the warning label 74a and the auxiliary label 20a is read very easily by the sight-impaired person.

It should be noted that neither the auxiliary label 20a nor the auxiliary label assembly 22a permanently obscures the legally dictated, standard prescription label 54.

Because a PVC static-cling vinyl is used, and not a low tack adhesive, dirt and grime which accumulates during use will not foul the adhesion of the auxiliary label 20a or the auxiliary label assembly 22a to either the prescription label 54 or the prescription container 56, which occurs with the low tack adhesive. In addition, handling an adhesive backed elongated strip is considerably more difficult and undesirable than would be a static cling wrap label.

It should be noted that, if desired, the first and second components 36a, 38a may first be removed from the form 24a before peeling the top layers 26a and the adhesives 34a secured thereto, if applicable, from the bottom layers 28a thereof, or the top layers 26a and the adhesives 34a secured thereto, if applicable, may be peeled from the bottom layers 28a thereof without first removing the first and second components 36a, 38a from the form 24a.

It is further to be understood that this invention may be advantageous to patients who are not sight impaired arid is not intended to be limiting in this regard. It should be further noted that the drawings are not necessarily drawn to scale.

While preferred embodiments of the present invention are shown and described, it is envisioned that those skilled in the art may devise various modifications of the present invention without departing from the spirit and scope of the foregoing description and the appended claims.

The invention is claimed as follows:

1. An auxiliary prescription label for securement to a prescription container having a primary prescription label, said auxiliary prescription label comprising:
a layer formed of a static-cling material, said layer having first and second surfaces and first and second ends, said first surface having information printed thereon; and
an adhesive secured to said second surface of said layer proximate to said second end, said adhesive configured to be secured to at least one of the prescription container and the primary prescription label such that a substantial portion of said layer can be releasably wrapped around at least a portion of the primary prescription label via static-cling.

2. The auxiliary prescription label as defined in claim 1, in combination with a prescription container, said prescription container including a prescription holding portion, a prescription label fixedly secured around at least a portion of said prescription holding portion; and
wherein said adhesive of said auxiliary label is secured to at least one of said prescription holding portion and said prescription label such that said layer of said auxiliary prescription label can be wrapped, and releasably secured via static-cling, around at least a portion of said prescription label.

3. The auxiliary prescription label in combination with the prescription container as defined in claim 2, wherein said layer of said auxiliary label is further wrapped, and further releasably secured via static-cling, to itself such that said second end of said layer of said auxiliary label overlaps said first end of said layer of said auxiliary label.

4. The auxiliary prescription label in combination with the prescription container as defined in claim 2, wherein said prescription label has prescription information provided thereon, and said information on said auxiliary prescription label is a subset of the prescription information provided on said prescription label.

5. The auxiliary prescription label in combination with the prescription container as defined in claim 4, wherein said information on said auxiliary prescription label is provided in large print so that a sight impaired person can read the information.

6. The auxiliary prescription label in combination with the prescription container as defined in claim 5, wherein said information on said auxiliary prescription label includes the name of the sight impaired person, the name of the drug in the prescription container, and instructions for administration of the drug to the patient.

7. The auxiliary prescription label as defined in claim 1, further comprising a warning label having a layer having first and second surfaces, and information printed on said first surface of said layer of said warning label, said second surface of said layer of said warning label being secured to said auxiliary label.

8. The auxiliary prescription label as defined in claim 7, wherein an adhesive is secured to said second surface of said layer of said warning label, said adhesive being secured to said second surface of said layer of the auxiliary label.

9. The auxiliary prescription label as defined in claim 7, wherein said layer of said warning label is attached to, and foldable relative to, said layer formed of a static-cling material.

10. The auxiliary prescription label as defined in claim 9, wherein a perforation line is provided between said layer of said warning label and said layer formed of a static-cling material.

11. The auxiliary prescription label as defined in claim 7, wherein said information on said warning label is provided in large print so that a sight impaired person can read the information.

12. The auxiliary prescription label as defined in claim 7, wherein said layer of said warning label is formed of a static-cling material.

13. The auxiliary prescription label as defined in claim 7, in combination with a prescription container, said prescription container including a prescription holding portion, a prescription label fixedly secured around at least a portion of said prescription holding portion; and
wherein said adhesive of said auxiliary label is secured to at least one of said prescription holding portion and said prescription label such that said auxiliary label and said warning label can be wrapped, and releasably secured via static-cling, around at least a portion of said prescription label.

14. The auxiliary prescription label in combination with the prescription container as defined to in claim 13, wherein said layer of said auxiliary label is further wrapped, and further releasably secured via static-cling, to itself such that said second end of said layer of said auxiliary label overlaps said first end of said layer of said auxiliary label.

15. The auxiliary prescription label as defined in claim 1, further comprising an RFID tag secured to said second surface of said layer.

16. The auxiliary prescription label as defined in claim 15, in combination with a prescription container, said prescription container including a prescription holding portion, a prescription label fixedly secured around at least a portion of said prescription holding portion; and
wherein said adhesive of said auxiliary label is secured to at least one of said prescription holding portion and said prescription label such that said auxiliary label and said RFID tag can be wrapped, and releasably secured via static-cling, around at least a portion of said prescription label.

17. The auxiliary prescription label in combination with the prescription container as defined in claim 16, wherein said layer of said auxiliary label is further wrapped, and further releasably secured via static-cling, to itself such that said second end of said layer of said auxiliary label overlaps said first end of said layer of said auxiliary label.

18. The auxiliary prescription label as defined in claim 1, wherein said information on said auxiliary prescription label is provided in large print so that a sight impaired person can read the information.

19. The auxiliary prescription label as defined in claim 18, wherein said information on said auxiliary prescription label includes the name of the sight impaired person, the name of the drug in the prescription container, and instructions for administration of the drug to the patient.

20. A label form comprising:
a top layer formed of a static-cling material which can have information printed thereon;
a bottom layer having first and second portions, said first portion of said bottom layer configured to be releasably secured to said top layer; and
a middle layer formed of an adhesive, said middle layer being positioned between said top layer and said second portion of said bottom layer, said middle layer being fixed to said top layer, said second portion of said bottom layer configured to be releasably secured to said middle layer.

21. The label form as defined in claim 20, wherein said static-cling material from which said top layer is formed is a PVC static-cling vinyl.

22. The label form as defined in claim 20, wherein said static-cling material from which said top layer is formed is configured to have laser fusion print from a laser printer adhered thereto.

23. The label form as defined in claim 20, wherein said adhesive from which said middle layer is formed is a pressure sensitive adhesive.

24. The label form as defined in claim 20, wherein at least one long label assembly having first and second ends is die cut into said label form.

25. The label form as defined in claim 24, wherein said at least one long label assembly has a first elongated portion and a second portion, said first elongated portion extending from said first end to said second condensed portion, said second portion extending from said first elongated portion to said second end, said first elongated portion formed from said top layer and said first portion of said bottom layer, said second portion formed from said top layer, said second portion of said bottom layer and said middle layer.

26. The label form as defined in claim 25, wherein said first elongated portion has a grab tag extending outwardly from said first end.

27. The label form as defined in claim 25, wherein at least one warning label assembly is die cut into said label form, said at least one warning label assembly is attached to said first elongated portion along a perforated line.

28. The label form as defined in claim 27, wherein said at least one warning label assembly is formed from said top layer and said first portion of said bottom layer.

29. The label form as defined in claim 25, wherein at least one warning label assembly is die cut into said label form, said at least one warning label assembly is foldably attached to said first elongated portion.

30. The label form as defined in claim 20, wherein at least one warning label assembly is die cut into said label form.

31. The label form as defined in claim 30, wherein said at least one warning label assembly is formed from said top layer, said second portion of said bottom layer and said middle layer.
